(19) United States
(12) Patent Application Publication
(10) Pub. No.: US 2008/0094329 A1
(43) Pub. Date: Apr. 24, 2008

(54) Color Display

(75) Inventor: Sander Jurgen Roosendaal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,537

(22) PCT Filed: Jul. 1, 2005
(86) PCT No.: PCT/IB05/52198

§ 371 Date: Jan. 2, 2007

(30) Foreign Application Priority Data
Jul. 7, 2004 (EP) 04103209.5

(51) Int. Cl. G09G 3/36; G02F 1/13357; G02F 1/139

(52) U.S. Cl. 345/88

(57) ABSTRACT

The present invention relates to a color display device, comprising at least two light sources (16, 17), having different radiance spectra, and a liquid crystal light valve layer (14). The light sources (16, 17) are activated sequentially and the light valve layer is provided with driving signals (d1, d2) in such a way that it obtains a strong wavelength dependence. This allows the display device to produce primary colors without the provision of color filters. This provides a less complex display, which is suitable for mobile applications and provides high brightness.

### FIELD OF THE INVENTION

The present invention relates to a color display device, for displaying a color image, comprising a liquid crystal light valve layer, having a plurality of picture elements arranged in an array, at least two light sources, having substantially different radiance spectra and being activated alternately, and color selection means for generating, together with said light sources, primary colors in said color image. The invention further relates to a method for controlling such a color display device.

### BACKGROUND OF THE INVENTION

Such a display device is disclosed in WO, 2004/032523, A1. This display device comprises pixels with two color filters, each being arranged in a sub-pixel, and uses two different selectable light sources, which are activated alternately. This arrangement allows a wider aperture for each pixel and an improved color gamut as compared with a conventional arrangement, comprising a white backlighting arrangement and three filters (RGB) for each pixel. A problem with this display is, however, that it is still quite complex compared to a black and white display.

### SUMMARY OF THE INVENTION

It is an object of the present invention to provide color display device, of the above indicated kind, with reduced complexity.

This object is achieved by means of a display device according to claim 1 and a method according to claim 9.

More specifically, the invention relates to a color display device, for displaying a color image, comprising a liquid crystal light valve layer, having a plurality of picture elements arranged in an array, at least two light sources, having substantially different radiance spectra and being activated alternately, and color selection means for generating, together with said light sources, primary colors in said color image, wherein said color selection means comprise driving means for supplying, to a picture element in the liquid crystal light valve layer, at least a first and a second driving signal, such that the picture element transmits light in a first transmission band when receiving the first driving signal, and transmits light in a second transmission band, different from the first transmission band, when receiving the second driving signal.

This allows the displaying of a plurality primary colors without the use of special color filters, which are expensive. Instead, the liquid crystal light valve layer itself is used to filter the incoming light. This provides a substantially less complex display device, with a greater aperture for each pixel.

The liquid crystal light valve layer may preferably be a non-twisted nematic liquid crystal layer. Such a layer provides an advantageous voltage to spectrum dependence.

As an alternative, an OCB mode LCD layer or a vertically aligned liquid crystal layer may be used. This entails a fast switching display.

The light sources may preferably comprise different light emitting diodes or different fluorescent lamps.

Preferably, the retardation value of the liquid crystal light valve layer is higher than 400 nm and even more preferred higher than 660 nm. This provides an advantageous wavelength-voltage dependence.

According to a second aspect, the invention relates to a method of controlling a color display device, for displaying a color image, the device comprising a liquid crystal light valve layer, having a plurality of picture elements arranged in an array, at least two light sources, having substantially different radiance spectra and being activated alternately, comprising the steps of supplying, to a picture element in the liquid crystal light valve layer, a first driving signal such that the picture element transmits light in a first transmission band, and supplying, to the picture element, a second driving signal, such that the picture element transmits light in a second transmission band, different from the first transmission band.

This method entails advantages corresponding to those of the above color display device.

These and other aspects of the invention will be apparent from and elucidated with reference to the embodiments described hereinafter.

### BRIEF DESCRIPTION OF THE DRAWINGS

FIGS. 1a and 1b illustrate a general principle of the present invention,

FIGS. 2a and 2b illustrate schematically a color display device according to an embodiment of the invention,

FIG. 3a illustrates a non-twisted nematic liquid crystal layer,

FIG. 3b illustrates transmission spectra for different driving voltages of the non-twisted nematic liquid crystal layer,

FIG. 4a illustrates an example where four light emitting diodes and two different transmission spectra are used,

FIG. 4b illustrates the color gamut of the example in FIG. 4a,

FIG. 5 illustrates a control arrangement used in a display device according to an embodiment of the invention,

### DESCRIPTION OF PREFERRED EMBODIMENTS

The present invention relates in general to a color display device that may be used in a television set, a computer monitor, a mobile phone display etc, to display still or video image information.

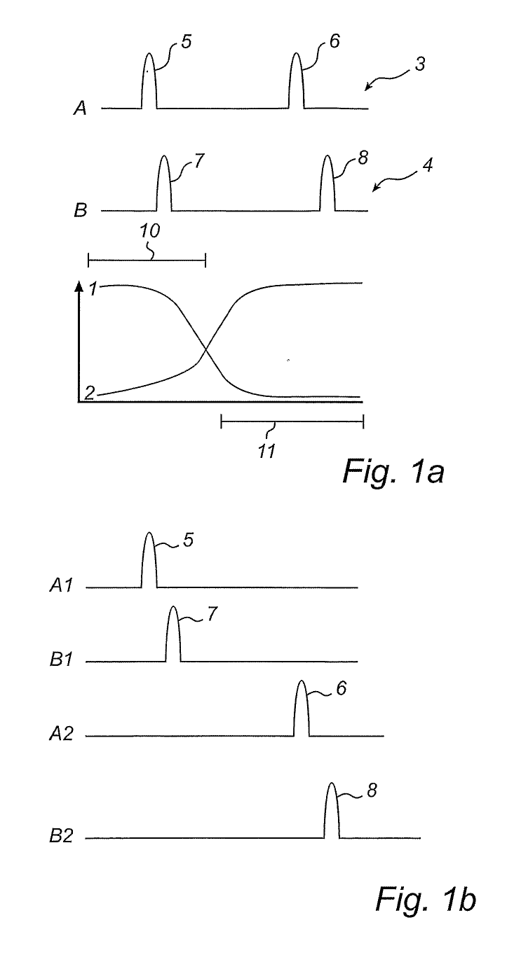

FIGS. 1a and 1b illustrate schematically a general principle of the present invention.

A display device according to an embodiment of the invention may comprise two light sources A and B, having different radiance spectra 3 and 4, respectively, as illustrated in FIG. 1a. The radiance spectrum 3 of a first light source A comprises two distinct colors 5, 6, e.g. blue 5 and yellow 6. The radiance spectrum 4 of a second light source B comprises two other distinct colors 7, 8, e.g. cyan 7 and red 8.

In accordance with an embodiment of the invention the display device further comprises a liquid crystal light valve layer, hereinafter called an LCD layer. The LCD layer is capable of being spectrum selective. Driving signals are provided to the LCD layer in such a way that that the transmission of the LCD layer has a strong wavelength dependence. When driven to a first state with a first voltage the LCD layer thus has a first transmission function 1, transmitting light with short wavelengths (blue, cyan) in a first transmission band 10. When driven to a second state with a second voltage the LCD layer has a second transmission function 2, transmitting light with longer wavelengths (yellow, red) in a second transmission band 11.

By using different combinations of the two light sources A and B and the LCD layer states, corresponding to different transmission functions 1 and 2, all primary colors 5, 6, 7, 8 may be produced individually in accordance with FIG. 1b and the following table:

| Light source | Transmission fcn | Primary color |
|---|---|---|
| A | 1 | Blue (5) |
| B | 1 | Cyan (7) |
| A | 2 | Yellow (6) |
| B | 2 | Red (8) |

In general, according to an embodiment of the present invention, the color display, described in WO, 2004/032523, A1, may be modified in such a way that the color selection means, which in that document comprises conventional color filters, is replaced by color selection means comprising a spectrum selective LCD layer and driving means for driving pixels of this layer to different spectrum selective states. This means that the whole area of the pixel is used to generate one color, rather than just the area of a sub-pixel.

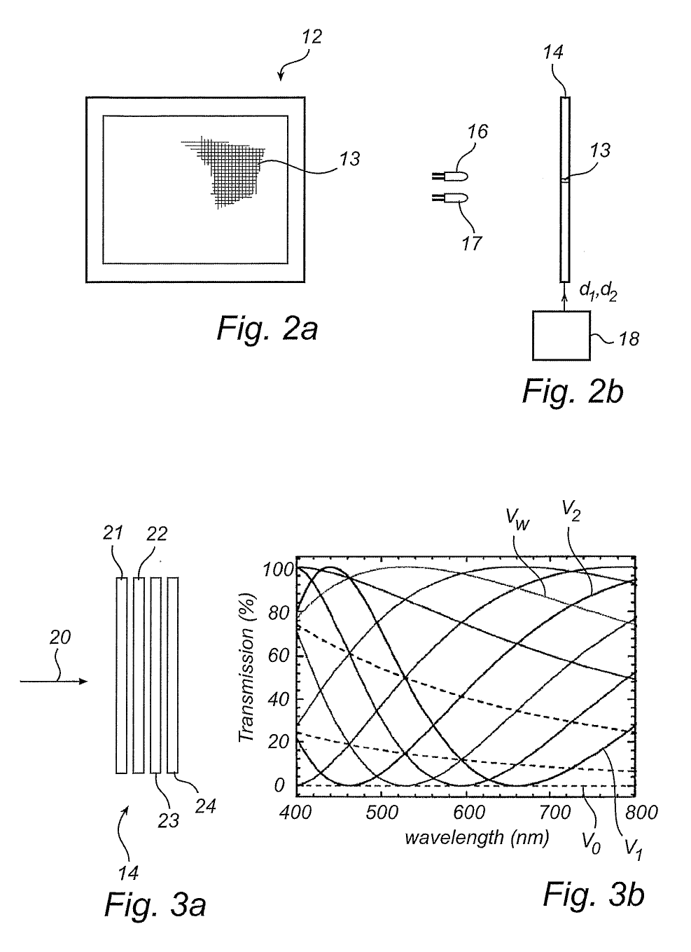

FIGS. 2a and 2b illustrate schematically a color display device according to an embodiment of the invention and realizing the general principle illustrated in FIGS. 1a and 1b.

FIG. 2a illustrates a color display 12, which may be used for displaying a color image. The display 12 comprises, a plurality of individually controllable picture elements, hereinafter called pixels 13, which are arranged in an array. FIG. 2b illustrates schematically a cross section through the display 12 in FIG. 2a. The display 12 comprises an LCD layer 14, which in turn comprises a number of layers, as will be described later. The display 12 further comprises at least two light sources 16, 17, having substantially different radiance spectra. The light sources 16, 17 are activated (flashed) alternately, in order to obtain a spectrum sequential display functionality, as will be described later. The display further comprises a driving unit 18, which is able to supply, to a picture element 13 in the LCD light layer 14, at least two different driving signals d₁, d₂. When a first driving signal d₁ is supplied to the pixel 13, the pixel 13 transmits light in a first transmission band. When a second driving signal d₂ is supplied to the pixel, the pixel transmits light in a second transmission band, which is different from the first transmission band.

A variety of light sources may be used, including HCFL (Hot Cathode Fluorescent Lamp) and light emitting diodes (LEDs). The light source A in FIG. 1a may thus comprise a blue LED and a yellow LED, whereas the light source B comprises a cyan LED and a red LED.

The LCD layer may be built up in various ways. An example of such an LCD layer 14 is schematically shown in FIG. 3a, namely a non-twisted nematic LCD layer, which is well known per se. This layer 14 comprises in the direction of a traveling light beam 20 (which may also travel in the opposite direction) a first polarizer 21 directed at 90°, a retarder 22 at 45° (retardation value d*Δₙ=660 nm (where d is the thickness and Δₙ is the birefringence value)), a non-twist liquid crystal layer 23 at −45° (d*Δₙ=660 nm), and a second polarizer 24 directed at 0°.

A conventional LCD effect has an effective retardation value of 275 nm (half wave), which rotates the polarization state of transmitted light 90°, which entails a dark pixel if the polarizers are parallel. Such a dark state is however obtained as long as

$$\frac{λ}{2 n + 1} = d * \frac{{Δ}_{n}}{2} ,$$

where λ is the wavelength. If for instance a dark state is needed at 400 nm, this can be achieved with a retardation value of 200 nm (n=0) or 600 nm (n=1). Higher retardation values result in greater wavelength dependence. For instance, for wavelengths slightly different from 400 nm, the difference between λ/(2n+1) and d*Δn/2 is greater for high n values. Therefore, if the retardation value is high, a state that is dark for 400 nm may be highly transparent for 700 nm.

The LCD schematically illustrated in FIG. 3a, as mentioned, has an extra retarder of 660 nm. This means that crossed polarizers should be used, providing a dark state with high quality at 0 V. Increasing the voltage means decreasing the retardation of the LC layer and increasing the total retardation value. At low voltages the effective retardation value is low and hence the transmission is quite color neutral. At a voltage depending on the used material and thickness, d*Δn is 275 nm and the bright state is reached. At even higher voltages the wavelength dependence occurs.

The non-twisted nematic LCD layer 14 thus has different transmission spectra for different driving electrode voltages, as is illustrated in FIG. 3b. For 0 V (V₀), the transmission is 0% for all wavelengths (black). At increasing voltages, the transmission percentage rises for all wavelengths until a voltage (V_{w}) where a substantially color neutral, white state is obtained (d*Δn=275 nm). Normally, a non-twisted liquid crystal layer is used in this color neutral interval. In accordance with an embodiment of the invention, the driving voltage is however increased further. This makes the LC layer highly wavelength dependent as explained above. At a first higher voltage (V₁), for example, the layer predominantly transmits light in a first transmission band below 500 nm. At a second, even higher voltage (V₂), the layer instead predominantly transmits light in a second transmission band above 500 nm.

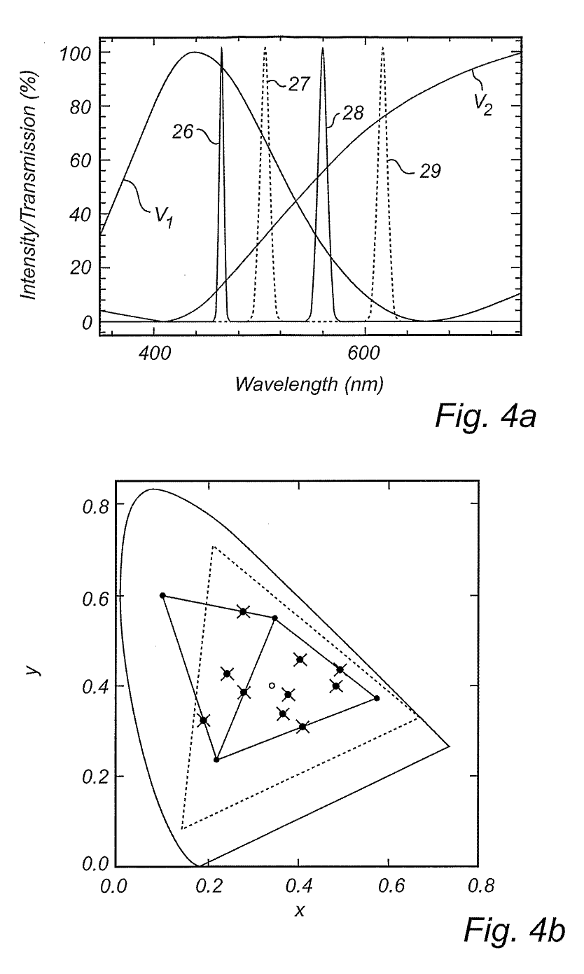

FIG. 4a illustrates an example where an embodiment of the invention is carried out. Two different transmission spectra (corresponding to V₁ and V₂) are chosen from FIG. 3b, and are used as spectrum selective states in the LC layer. In addition to the spectrum selective states, black and white states are also used. Four light emitting diodes 26, 27, 28, 29 (blue, cyan, yellow, red) are used as light sources, and are activated in pairs 26, 28 (continuous line) and 27, 29, (dashed line), respectively. With this arrangement four primary colors as well as black and white may be obtained.

FIG. 4b illustrates the color gamut of the example in FIG. 4a. The four primary colors are indicated as black spots. The color gamut is regarded as very large for a mobile application, such as a PDA or a mobile phone. The broken line triangle illustrates, as a comparison, the NTSC (National Television System Committee) color triangle.

In addition to the four primary colors, white (indicated by a ring) and ten additional colors (crosses) can be obtained, plus of course black. A total of 16 colors can thus be obtained with excellent brightness and using an inexpensive arrangement with low complexity. By using more than two spectrum selective states, more colors can of course be obtained at the cost of higher complexity.

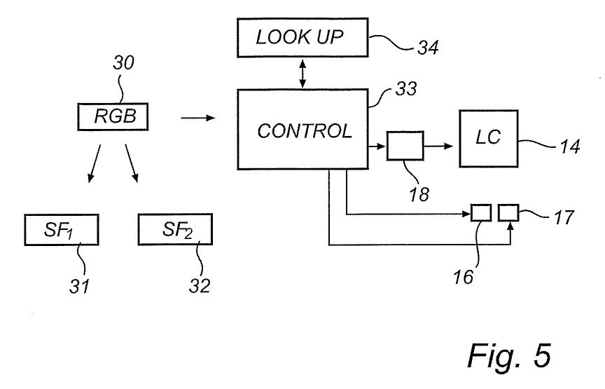

FIG. 5 illustrates a control arrangement used in a display device according to an embodiment of the invention. The control arrangement realizes a method of controlling the color display device. A control unit 33 receives image information (video or still) in the form of RGB frames 30 to be displayed. The control unit 33 serves to divide each incoming frame 30 into a first SF₁, 31, and a second SF₂, 32, sub-frame, which, when displayed one immediately after the other, together give the perceptual appearance of the RGB frame 30. The control unit 33 displays the first sub-frame 31 by flashing a first light source 16 after making a driving unit 18 feed a first driving signal d₂ to the LC light valve layer 14. The control unit 33 displays the second sub-frame 32 by flashing a second light source 17 after making a driving unit 18 feed a second driving signal d₂ to the LC light valve layer 14. The addressing method per se may be conventional.

A total frame length is normally 20 ms, which means that, for each sub-frame 10 ms is available. This time period can be used in the following way. First the pixel is addressed, which is done during 2 ms, then during 7 ms the system waits for the pixel response, i.e. for the pixel to attain the desired state. Then the light source/sources are flashed during 1 ms.

If the received information relates to a still image, this is repeated as long as the image is displayed. Note that the LC light valve layer 14 controls both luminance (grey scale) and color. A given RGB frame 30 corresponds to a best possible approximation given by the two driving signals d₁ d₂, which are found for each frame, using e.g. a lookup table 34.

It should be noted that other LC light valve layers than the non-twisted nematic, illustrated in FIG. 3a, may be used. The skilled person can find out numerous ways of achieving the required voltage-wavelength dependence. The highest total retardation value of the display should preferably be higher than 400 nm and even more preferred higher than 660 nm.

In a first variation a vertically aligned LC layer may be used. This variation may provides substantially the same optical properties as is described in 3b, but for different driving voltages. An advantage with this variation is that black is achieved at a high voltage, which means that the display can be driven to the black state, as compared to the above described case where the black state is relaxed. This improves the switching speed of the display.

In another variation, the retarder 22 in FIG. 3a is left out. This also positions the black state at a high drive voltage.

Another conceivable variation includes using an OCB (Optical Compensated Birefringence) mode LCD, which is also well known to the skilled person. The OCB mode LCD also provides fast switching.

In summary, the invention relates to a color display device, comprising at least two light sources, having different radiance spectra, and a liquid crystal light valve layer. The light sources are activated sequentially and the light valve layer is provided with driving signals in such a way that it obtains a strong wavelength dependence. This allows the display device to produce primary colors without the provision of color filters. This provides a less complex display, which is suitable for mobile applications and provides high brightness.

The invention is not restricted to the described embodiments. It can be altered in different ways within the scope of the appended claims.

1. A color display device, for displaying a color image, comprising a liquid crystal light valve layer (14), having a plurality of picture elements (13) arranged in an array, at least two light sources (16, 17), having substantially different radiance spectra and being activated alternately, and color selection means for generating, together with said light sources, primary colors in said color image, wherein said color selection means comprise driving means (18) for supplying, to a picture element in the liquid crystal light valve layer (14), at least a first and a second driving signal (d1, d2), such that the picture element transmits light in a first transmission band when receiving the first driving signal (d1), and transmits light in a second transmission band, different from the first transmission band, when receiving the second driving signal (d2).

2. A color display device according to claim 1, wherein the liquid crystal light valve layer (14) is a non-twisted nematic liquid crystal layer.

3. A color display device according to claim 1, wherein the liquid crystal light valve layer (14) is an OCB mode liquid crystal layer.

4. A color display device according to claim 1, wherein the liquid crystal light valve layer (14) is a vertically aligned liquid crystal layer.

5. A color display device according to claim 1, wherein said light sources (16, 17) comprise different light emitting diodes.

6. A color display device according to claim 1, wherein said light sources (16, 17) comprise different fluorescent lamps.

7. A color display device according to claim 1, wherein the retardation value of the liquid crystal light valve layer (14) is higher than 400 nm.

8. A color display device according to claim 7, wherein the retardation value of the liquid crystal light valve layer (14) is higher than 660 nm.

9. A method of controlling a color display device, for displaying a color image, the device comprising a liquid crystal light valve layer (14), having a plurality of picture elements (13) arranged in an array, at least two light sources (16, 17), having substantially different radiance spectra and being activated alternately, comprising the steps of
supplying, to a picture element in the liquid crystal light valve layer (14), a first driving signal (d1) such that the picture element transmits light in a first transmission band, and
supplying, to the picture element (14), a second driving signal (d1), such that the picture element transmits light in a second transmission band, different from the first transmission band.
